(19) United States
(12) Patent Application Publication
(10) Pub. No.: US 2020/0064219 A1
(43) Pub. Date: Feb. 27, 2020

(54) PIPELINE INSPECTION CRAWLER

(71) Applicant: Accenture Global Solutions Limited, Dublin (IE)

(72) Inventor: Nicholas Akiona, San Jose, CA (US)

(21) Appl. No.: 16/549,779

(22) Filed: Aug. 23, 2019

Related U.S. Application Data
(60) Provisional application No. 62/722,015, filed on Aug. 23, 2018.

(51) Int. Cl. G01M 3/00; G01S 17/89; G01M 3/38; G01S 7/481

(52) U.S. Cl. CPC G01M 3/005; G01S 7/4811; G01M 3/38; G01S 17/89

(57) ABSTRACT

Methods, systems, and apparatus, including computer programs encoded on a computer storage medium, for a pipeline inspection crawler configured to inspect interior or exterior sections of pipes that extend along a pipeline. The pipeline inspection crawler includes a chassis, a transmitter assembly connected to the chassis, and a receiver assembly connected to the chassis. The transmitter assembly includes a transmitter arm, a transmitter to position the transmitter arm relative to a center of the pipe, and a transmitter disposed on the transmitter arm to transmit a signal used to inspect the pipe. The receiver assembly includes a receiver arm, a receiver motor to position the receiver arm relative to the center of the pipe, and a receiver disposed on the receiver arm to receive the transmitted signal used to inspect the pipe. The transmitter interacts with the receiver to generate imaging data for inspecting sections of the pipe.

### CROSS REFERENCE TO RELATED APPLICATION

This application claims the benefit of U.S. Provisional Application No. 62/722,015, filed on Aug. 23, 2018, which is incorporated herein by reference in its entirety.

### FIELD

This specification relates to mechanical inspection systems.

### BACKGROUND

Crawler systems are capable of capturing images of pipes that form an extended series of pipelines. The systems facilitate inspection of various sections of a pipe by identifying characteristics such as porosity and cracks at an interior surface of a pipe in accordance with a set of inspection criteria. In some cases, these pipeline crawling systems can be used to detect the quality of welding processes used in pipelines that extend for long distances.

### SUMMARY

Techniques are described for implementing a pipeline inspection crawler configured to inspect interior or exterior sections of pipes that extend along a pipeline. The pipeline inspection crawler includes a chassis, a transmitter assembly connected to the chassis, and a receiver assembly connected to the chassis. The transmitter assembly includes a transmitter arm, a transmitter to position the transmitter arm relative to a center of the pipe, and a transmitter disposed on the transmitter arm to transmit a signal used to inspect the pipe. The receiver assembly includes a receiver arm, a receiver motor to position the receiver arm relative to the center of the pipe, and a receiver disposed on the receiver arm to receive the transmitted signal used to inspect the pipe. The transmitter interacts with the receiver to generate imaging data for inspecting sections of the pipe.

One aspect of the subject matter described in this specification can be embodied in a pipeline crawler for inspecting a pipe. The pipeline crawler includes a chassis for supporting one or more assembly items that may be connected to the chassis. The pipeline crawler includes a transmitter assembly connected to the chassis. The transmitter assembly includes: an arc-shaped transmitter arm having a first end and a second end, a first transmitter motor that is configured to position the arc-shaped transmitter arm relative to a center of the pipe, a transmitter disposed on the first end of the arc-shaped transmitter arm, a second transmitter motor that is attached to the first end of the arc-shaped transmitter arm and that is configured to position the transmitter relative to the arc-shaped transmitter arm, and a transmitter counterweight that is attached to the second end of the arc-shaped transmitter arm.

The pipeline crawler further includes a receiver assembly connected to the chassis. The receiver assembly includes: an arc-shaped receiver arm having a first end and a second end, a first receiver motor that is configured to position the arc-shaped receiver arm relative to the center of the pipe, a receiver disposed on the second end of the arc-shaped receiver arm, wherein the transmitter interacts with the receiver to generate imaging data that describes a particular section of the pipe, a second receiver motor that is attached to the second end of the arc-shaped receiver arm and that is configured to position the receiver relative to the arc-shaped receiver arm, and a receiver counterweight that is attached to the first end of the arc-shaped receiver arm.

These and other implementations can each optionally include one or more of the following features. For example, in some implementations, the arc-shaped transmitter arm has a first radius and the arc-shaped receiver arm has a second radius that is equal to the first radius of the arc-shaped transmitter arm. In some implementations, the first radius and the second radius are each greater than a radius of the pipe.

In some implementations, the first transmitter motor is configured to position the arc-shaped transmitter arm relative to the center of the pipe by rotating the arc-shaped transmitter arm around the center of the pipe. In some implementations, a weight of the transmitter counterweight and a weight of the receiver counterweight are selected so as to place an overall center of mass of the pipeline crawler above the center of the pipe.

In some implementations, the pipeline crawler further includes one or more mounts for supporting the pipeline crawler atop a pipeline. In some implementations, each mount of the one or more mounts includes a respective wheel that is connected to the chassis. In some implementations, the pipeline crawler further includes a drive motor that: (i) is affixed to the chassis; and (ii) is configured to rotate a wheel connected to the chassis so as to move the pipeline crawler along the pipeline.

One aspect of the subject matter described in this specification can be embodied in a method for inspecting a pipe using a pipeline crawler. The method includes (i) positioning, using a first transmitter motor, an arc-shaped transmitter arm of a transmitter assembly relative to a center of the pipe, wherein the transmitter assembly is connected to a chassis of the pipeline crawler and includes the first transmitter motor and (ii) positioning, using a second transmitter motor, a transmitter of the transmitter assembly relative to the arc-shaped transmitter arm, wherein the transmitter is disposed on a first end of the arc-shaped transmitter arm.

The method further includes (i) positioning, using a first receiver motor, an arc-shaped receiver arm of a receiver assembly relative to the center of the pipe, wherein the receiver assembly is connected to the chassis of the pipeline crawler and includes the first receiver motor and (ii) positioning, using a second receiver motor, a receiver of the receiver assembly relative to the arc-shaped receiver arm, wherein the receiver is disposed on a second end of the arc-shaped receiver arm. The method includes generating an image of the pipe using the positioned transmitter disposed on the first end of the positioned arc-shaped transmitter arm and the positioned receiver disposed on the second end of the positioned arc-shaped receiver arm.

These and other implementations can each optionally include one or more of the following features. For example, in some implementations, the method further includes positioning, using the first transmitter motor, a transmitter counterweight of the transmitter assembly relative to the center of the pipe, wherein the transmitter counterweight is attached to a second end of the arc-shaped transmitter arm. In some implementations, the method further includes positioning, using the first receiver motor, a receiver counterweight of the receiver assembly relative to the center of the pipe, wherein the receiver counterweight is attached to a first end of the arc-shaped receiver arm.

In some implementations, the method further includes selecting a weight of the transmitter counterweight; and selecting a weight of the receiver counterweight; wherein the weight of the transmitter counterweight and the weight of the receiver counterweight are each selected so as to place an overall center of mass of the pipeline crawler above the center of the pipe.

In some implementations, the method further includes supporting the pipeline crawler atop a pipeline using one or more mounts, wherein each mount of the one or more mounts comprises a respective wheel that is connected to the chassis of the pipeline crawler. In some implementations, the method further includes using a drive motor affixed to the chassis to move the pipeline crawler along the pipeline, wherein the drive motor is configured to rotate a wheel connected to the chassis to cause the pipeline crawler to move along the pipeline.

In some implementations, generating the image of the pipe includes generating multiple discrete images that each capture information about a respective interior or exterior section of the pipe; and generating the image of the pipe in response to combining each of the multiple discrete images. In some implementations, positioning the arc-shaped transmitter arm relative to the center of the pipe includes rotating the arc-shaped transmitter arm around the center of the pipe. In some implementations, the arc-shaped transmitter arm has a first radius and the arc-shaped receiver arm has a second radius that is equal to the first radius of the arc-shaped transmitter arm; and the first radius and the second radius are each greater than a radius of the pipe.

One aspect of the subject matter described in this specification can be embodied in a method for manufacturing a pipeline crawler. The method includes providing a chassis for supporting one or more assembly items that may be connected to the chassis. The method includes connecting a transmitter assembly to the chassis and connecting a receiver assembly to the chassis. In some implementations, the method for manufacturing the pipeline crawler further includes connecting one or more mounts to the chassis to support the pipeline crawler atop a pipeline. Each mount of the one or more mounts can include a respective wheel that is connected to the chassis. In some implementations, the method for manufacturing the pipeline crawler further includes affixing a drive motor to the chassis and to the one or more mounts connected to the chassis. The drive motor is configured to rotate the respective wheel connected to the chassis so as to move the pipeline crawler along the pipeline.

Other implementations of this and other aspects can include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The subject matter described in this specification can be implemented in particular implementations and can result in one or more of the following advantages. The described techniques can be used to produce a pipeline inspection crawler configured to automatically inspect small diameter pipelines for corrosion under insulation. When performing an inspection, the pipeline inspection crawler employs mechanisms that enable imaging sensors of the crawler to be uniquely positioned relative to a central axis of a pipe being inspected. This unique positioning enabled by the mechanisms allows the imaging sensors to capture different images of a pipeline from various angles or tangential angles. A pipeline inspection crawler can be specifically sized to enable detailed inspection of various small diameter pipelines (e.g., with pipes less than six inches in diameter). Thus, improvements to pipeline corrosion inspection can be realized from using a pipeline inspection crawler produced based on the described techniques.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 show an example diagram of a pipeline inspection crawler.

FIG. 2 shows an example first implementation of a pipeline inspection crawler.

FIG. 3 shows an example second implementation of a pipeline inspection crawler.

FIG. 4 shows an example third implementation of a pipeline inspection crawler.

FIG. 5 shows an example method for inspecting a pipe using a pipeline inspection crawler.

FIG. 6 shows an example distribution of mass for a pipeline inspection crawler that is positioned on a pipeline.

Like reference numbers and designations in the various drawings indicate like elements.

### DETAILED DESCRIPTION

This document describes techniques for implementing and using a pipeline inspection crawler that is configured to autonomously inspect a pipeline for corrosion. The pipeline inspection crawler can be a device such as a robotic crawler designed and manufactured to travel along a series of interconnected pipes that form a pipeline. The pipeline inspection device inspects each of the interconnected pipes of a pipeline for corrosion using one or more types of sensors.

In this context, a device for inspecting pipes along a pipeline is described. A pipeline crawler includes a chassis, a transmitter assembly that is connected to the chassis, and a receiver assembly that is also connected to the chassis. The transmitter assembly includes an arc-shaped transmitter arm having a first end and a second end and a first transmitter motor that is configured to position the arc-shaped transmitter arm relative to a center of the pipe. The transmitter assembly also includes a transmitter disposed on the first end of the arc-shaped transmitter arm, a second transmitter motor that is attached to the first end of the arc-shaped transmitter arm and that is configured to position the transmitter relative to the arc-shaped transmitter arm, and a transmitter counterweight that is attached to the second end of the arc-shaped transmitter arm.

The receiver assembly includes an arc-shaped receiver arm that has a first end and a second end and a first receiver motor that is configured to position the arc-shaped receiver arm relative to the center of the pipe. The receiver assembly also includes a receiver disposed on the second end of the arc-shaped receiver arm, a second receiver motor that is attached to the second end of the arc-shaped receiver arm and that is configured to position the receiver relative to the arc-shaped receiver arm, and a receiver counterweight that is attached to the first end of the arc-shaped receiver arm. The transmitter interacts with the receiver to generate sensor or imaging data that describes a particular section of the pipes.

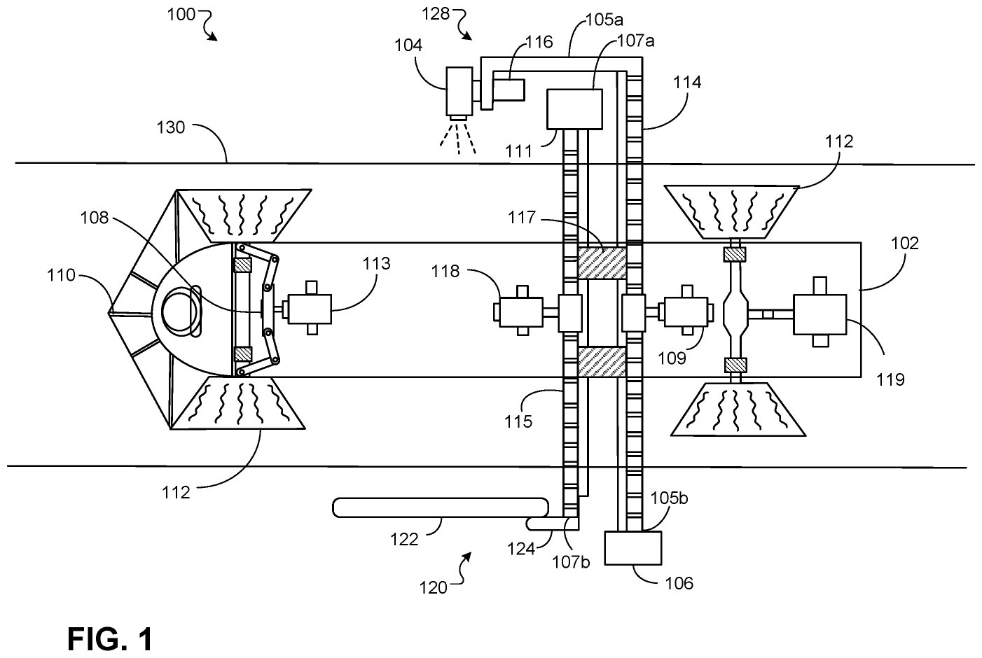

FIG. 1 shows a block diagram of a pipeline inspection crawler 100. Crawler 100 is a pipeline crawler for inspecting a pipe that may be a portion of an extended pipeline. The crawler 100 includes a chassis 102 that forms a frame structure to which other components of the crawler 100 are attached. The chassis is operable to support one or more assembly items that may be connected to the chassis. The crawler 100 includes a transmitter assembly 128 that is connected to the chassis 102. The transmitter assembly 128 includes an arc-shaped transmitter arm 114 that has a first end 105a and a second end 105b. Each of the first end 105a and the second end 105b are described in more detail below.

The transmitter assembly 128 further includes a first transmitter motor 109 that is configured to position the arc-shaped transmitter arm 114 relative to a center of the pipe 130. The transmitter assembly 128 further includes a transmitter 104 disposed on the first end 105a of the arc-shaped transmitter arm 114 and a second transmitter motor 116 that is attached to the first end 105a of the arc-shaped transmitter arm 114 and that is configured to position the transmitter 104 relative to the arc-shaped transmitter arm 114. The transmitter assembly 128 further includes a transmitter counterweight 106 that is attached to the second end 105b of the arc-shaped transmitter arm 114.

The crawler 100 further includes a receiver assembly 120 connected to the chassis 102. The receiver assembly 120 includes an arc-shaped receiver arm 115 that has a first end 107a and a second end 107b. Each of the first end 107a and the second end 107b are described in more detail below. The receiver assembly 120 further includes a first receiver motor 118 that is configured to position the arc-shaped receiver arm 115 relative to the center of the pipe 130 and a receiver 122 (e.g., a TRT receiver) disposed on the second end 107b of the arc-shaped receiver arm 115. The transmitter 104 interacts with the receiver 122 to generate imaging data that describes a particular section of the pipe.

The receiver assembly 120 further includes a second receiver motor 124 that is attached to the second end 107b of the arc-shaped receiver arm 115 and that is configured to position the receiver 122 relative to the arc-shaped receiver arm 115. The receiver assembly 120 also includes a receiver counterweight 111 that is attached to the first end 107a of the arc-shaped receiver arm 115. The crawler 100 can include an arm support structure 117 configured to secure each of the first transmitter motor 109, the arc-shaped transmitter arm 114, the arc-shaped receiver arm 115, and the first receiver motor 118 to the chassis 102 of the crawler 100. In some cases, the support structure 117 can include one or more motor mounts for mounting the motors 109, 118. In some implementations, the crawler 100 includes a plow attachment 110 attached to a front section of the crawler and a steering mechanism 108 that is at least partially controlled or engaged using a steering motor 113.

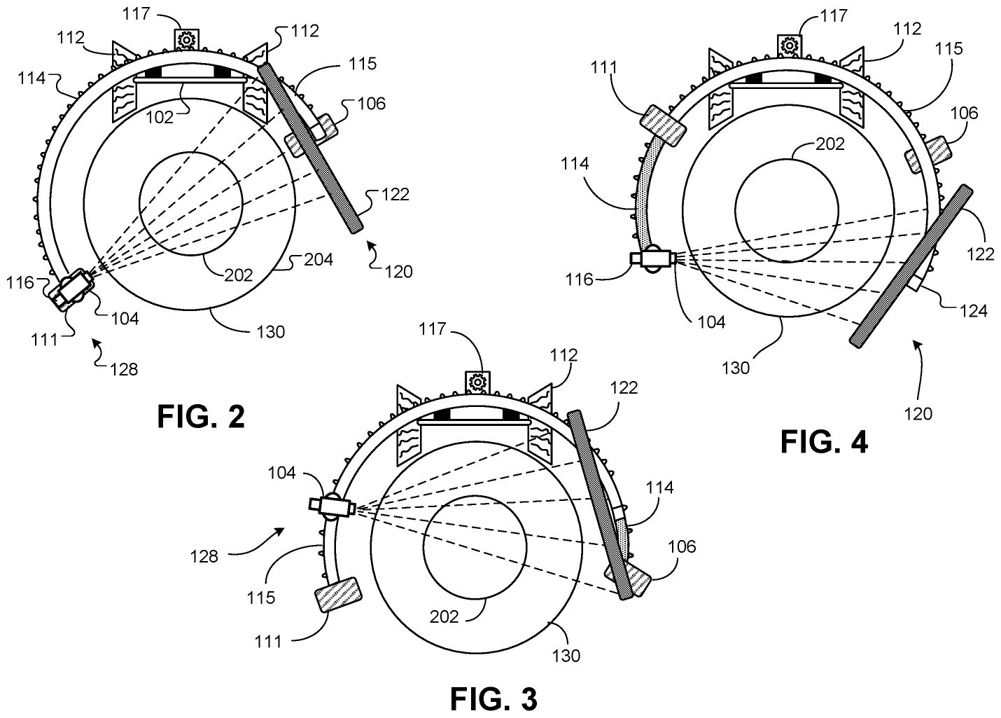

Each of FIG. 2, FIG. 3, and FIG. 4 shows example implementations of a pipeline inspection crawler. As shown in these implementations, the arc-shaped transmitter arm 114 can have a first radius and the arc-shaped receiver arm 115 can have a second radius that is equal to the first radius of the arc-shaped transmitter arm 114. In some implementations, the first radius and the second radius are each greater than a radius of the pipe 130. The first transmitter motor 109 is configured to position the arc-shaped transmitter arm 114 relative to the center of the pipe 130 by rotating the arc-shaped transmitter arm 114 around the center of the pipe 130.

In some implementations, a weight of the transmitter counterweight 106 and a weight of the receiver counterweight 111 are selected so as to place an overall center of mass of the pipeline crawler 100 above the center of the pipe 130. In some implementations, crawler 100 further includes one or more mounts for supporting the pipeline crawler 100 atop a pipeline 130. In some implementations, each mount of the one or more mounts comprises a respective wheel 112 that is connected to the chassis 102. The pipeline crawler 100 may further a drive motor 119 that (i) is affixed to the chassis 102; and (ii) is configured to rotate a wheel 112 connected to the chassis 102 so as to move the pipeline crawler 100 along the pipeline 130.

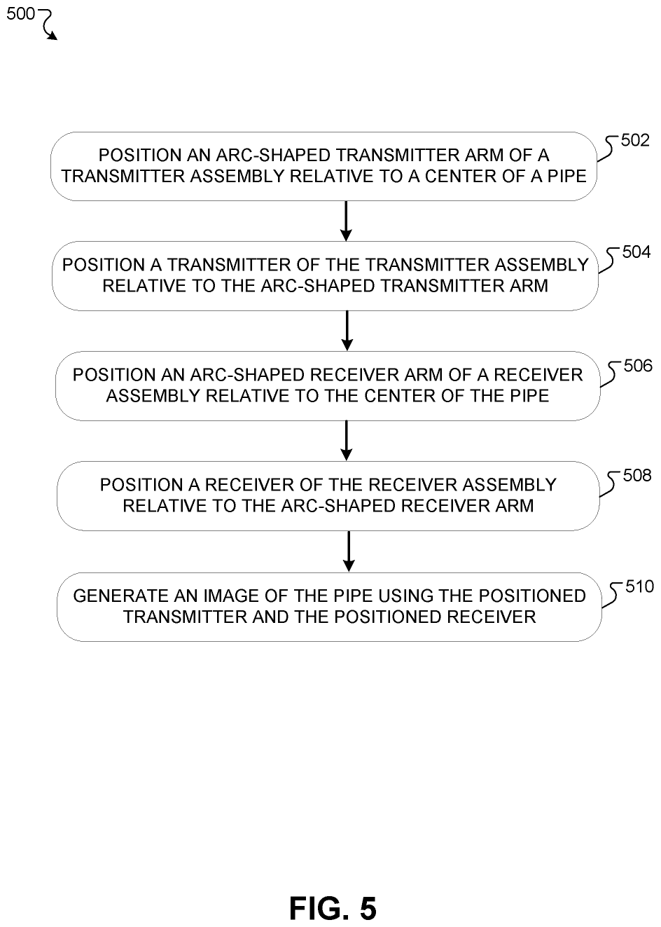

The respective example implementations of FIG. 2, FIG. 3, and FIG. 4 are associated with a method for inspecting a pipe using a pipeline crawler. The method can correspond to an example process described below with reference to FIG. 5.

FIG. 5 shows an example method or process 500 for inspecting a pipe using a pipeline inspection crawler, such as the pipeline inspection crawler 100 described herein with reference to one or more of the figures.

In some implementations, steps or actions of the process 500 are performed using corresponding systems, apparatus, or a controller of an inspection crawler. For example, the controller can include computing systems of one or more computers or hardware circuits that are operable to cause a pipeline inspection crawler to perform the actions of example methods and processes described in this document. In some implementations, the controller executes computer programs to generate control signals to at least actuate various motorized controls of a crawler 100, where the control signals are used to cause performance of one or more actions of process 500.

This process 500 can include positioning a transmitter arm of a transmitter assembly relative to a center of a pipe (502). For example, a controller of the pipeline inspection crawler 100 is operable to generate a control signal to position the arc-shaped transmitter arm 114 of the transmitter assembly 128 relative to the center of a pipe 130 using a first transmitter motor 109. In some implementations, the first transmitter motor 109 is coupled to the transmitter arm 114 and the controller provides the control signal to the first transmitter motor 109 to actuate the motor to position the transmitter arm 114 in response to providing the control signal to the transmitter motor 109.

Process 500 further includes positioning a transmitter of a transmitter assembly relative to transmitter arm (504). For example, the controller of the pipeline inspection crawler 100 is operable to generate a control signal to position the transmitter 104 (e.g., a TRT transmitter) of the transmitter assembly 128 relative to the arc-shaped transmitter arm 114 using the second transmitter motor 116. In some implementations, the second transmitter motor 116 is coupled to the transmitter 104 and the controller provides the control signal to the second transmitter motor 116 to actuate the motor to position the transmitter 104 in response to providing the control signal to the transmitter motor 116.

Process 500 can further include positioning a receiver arm of a receiver assembly relative to a center of a pipe (506). For example, a controller of the pipeline inspection crawler 100 is operable to generate a control signal to position the arc-shaped receiver arm 115 of the receiver assembly 120 relative to the center of the pipe 130 using a first receiver motor 118. In some implementations, the first receiver motor 118 is coupled to the receiver arm 115 and the controller provides the control signal to the first receiver motor 118 to actuate the motor to position the receiver arm 115 in response to providing the control signal to the receiver motor 118.

Process 500 further includes positioning a receiver of a receiver assembly relative to receiver arm (508). For example, the controller of the pipeline inspection crawler 100 is operable to generate a control signal to position the receiver 122 (e.g., a TRT receiver) of the receiver assembly 120 relative to the arc-shaped receiver arm 115 using the second receiver motor 124. In some implementations, the second receiver motor 124 is coupled to the receiver 122 and the controller provides the control signal to the second receiver motor 124 to actuate the motor to position the receiver 122 in response to providing the control signal to the second receiver motor 124.

Process 500 further includes generating an image of a section of a pipe using a transmitter and a receiver of a pipeline inspection crawler (510). For example, the controller of the pipeline inspection crawler 100 is operable to generate a control signal to cause the transmitter 104 to transmit a signal for inspecting an interior section of pipe 130 or to inspect an exterior section of the pipe 130. In some implementations, in response to, or concurrent with, causing the transmitter 104 to transmit the signal for inspecting one or more sections of the pipe 130, the controller can also generate a control signal to cause the receiver 122 to detect, receive, or otherwise process at least a portion of the signal transmitted by transmitter 104.

The pipeline inspection crawler 100 uses data values of the signal received by the receiver 122 to generate an image of an interior section 202 or an exterior section 204 of the pipe 130 as well as to perform an inspection of the interior or the exterior sections of the pipe 130 based on the representations in the imagery of the various sections of the pipe. In some cases, the pipeline inspection crawler 100 includes on-board circuitry and image processing capability for generating images of the pipe 130 using the data values of signals received by the receiver 122. In some implementations, the controller of the pipeline inspection crawler 100 transmits (e.g., wirelessly transmit) the data values to a server or cloud-based system for processing the data values to generate the images of the pipe 130.

In some implementations, pipeline inspection crawler 100 employs LiDAR (Light Detection and Ranging) technology and other detection technology as a surveying method for evaluating or inspecting small diameter pipelines for corrosion under insulation (CUI). In some examples, remote server-based systems, as well as local computing systems of the pipeline inspection crawler 100, can use the transmitter 104 and receiver 122 to measure distances to a target (e.g., interior section 202) by using the transmitter 104 to illuminate the target with laser light and the receiver 122 to measure the reflected light with one or more sensors integrated in the receiver 122. Differences in laser light return times and light wavelengths can be used to generate imagery or digital representations of a target item such as a particular section of a pipe or pipeline.

In some implementations, the LiDAR data values are in the form of data sets for a three-dimensional (3D) and 360 degree field-of-view (FOV) range of analysis. The datasets can consist of x, y, z coordinates, along with laser light intensity values associated with signals detected or received by the receiver 122. The coordinates x, y and z can represent a position of each point of a section of the pipe 130 relative to a origin centered within a LiDAR transmitter 104, such as an origin that is the center of the pipe 130. The laser light intensity values associated with signals detected or received by the receiver 122 can represent a strength of reflected signals transmitted by transmitter 104.

In some examples, objects associated with an interior or exterior section 202, 204 of a pipe 130 that is under inspection can appear at different scales based on their distance to an example LiDAR transmitter 104. In some implementations, these objects are viewable from any angle based on a positioning of the arc-shaped transmitter arm relative to the center of the pipe 130, e.g., by rotating the arc-shaped transmitter arm around the center of the pipe 130.

The positioned transmitter 104 can be disposed on the first end 105a of the positioned arc-shaped transmitter arm 114 and the positioned receiver 122 can be disposed on the second end 107b of the positioned arc-shaped receiver arm 115. Each of the arc-shaped transmitter arm 114 and the arc-shaped receiver arm 115 are independently controlled at the crawler 100 using the respective motors 109, 116 and motors 118, 124. The combination of the two independently controlled arc-shaped transmitter and receiver arms 114, 115 provide the ability for the crawler 100 to change the angle of the transmitter 104 and receiver 122, which in-turn allows the crawler 100 to capture a wide array of images.

For example, the transmitter 104 and receiver 122 can be used to capture images of various interior sections 202 and exterior sections 204 of the pipe 130, and through the center axis of the pipe 130, by positioning the transmitter 104 and receiver 122 at different tangential angles relative to an interior section 202 of the pipe 130. In some implementations, crawler 100 can obtain nearly 360 degree image coverage of interior sections 202 of the pipe 130. This coverage can be improved further by trailing the transmitter 102 and receiver 122 behind a base of the crawler 100.

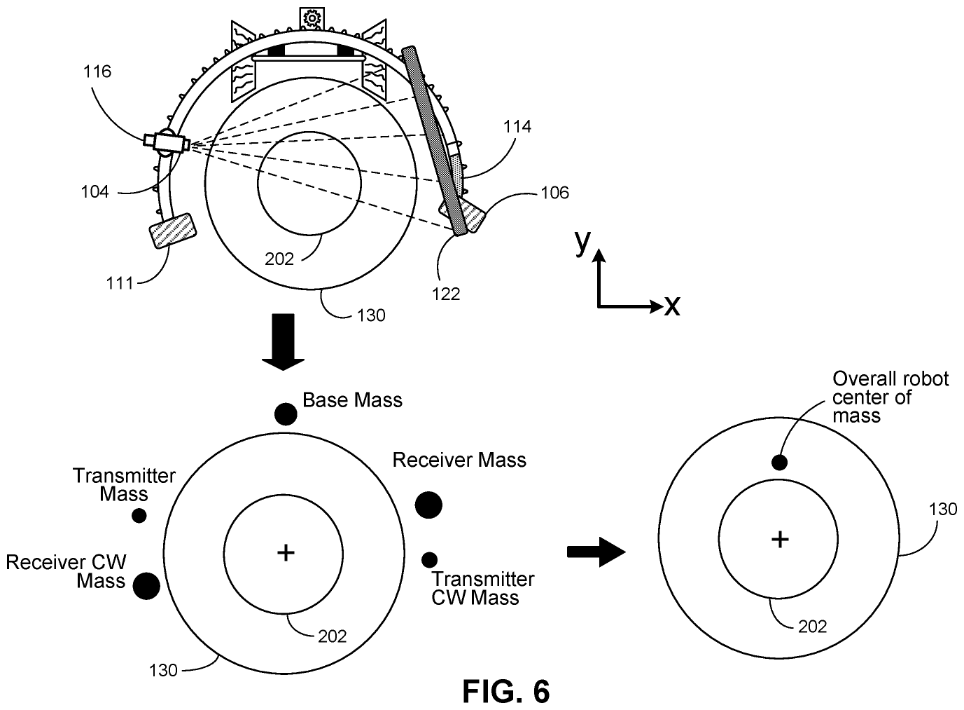

FIG. 6 shows an example distribution of mass for a pipeline inspection crawler that is positioned on a pipeline. In some implementations, the respective counterweights are designed and select to ensure the crawler 100 remains stable atop the pipe 130 irrespective of a position of the crawler 100 being offset (e.g., slightly or substantially) offset from the center of the pipe 130. For example, the weight or mass of the transmitter counterweight 106 and the weight or mass of the receiver counterweight 111 can be selected so as to place an overall center of mass of the crawler 100 above the center of the pipe 130. In some implementations, the weight or mass of the transmitter counterweight 106 and the weight or mass of the receiver counterweight 111 are each selected or determined with reference to a weight/mass of the transmitter 104 and/or a weight/mass of the receiver 122.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A pipeline crawler for inspecting a pipe, the pipeline crawler comprising:
a chassis;
a transmitter assembly connected to the chassis, the transmitter assembly including:
an arc-shaped transmitter arm having a first end and a second end,
a first transmitter motor that is configured to position the arc-shaped transmitter arm relative to a center of the pipe,
a transmitter disposed on the first end of the arc-shaped transmitter arm,
a second transmitter motor that is attached to the first end of the arc-shaped transmitter arm and that is configured to position the transmitter relative to the arc-shaped transmitter arm, and
a transmitter counterweight that is attached to the second end of the arc-shaped transmitter arm; and
a receiver assembly connected to the chassis, the receiver assembly including:
an arc-shaped receiver arm having a first end and a second end,
a first receiver motor that is configured to position the arc-shaped receiver arm relative to the center of the pipe,
a receiver disposed on the second end of the arc-shaped receiver arm, wherein the transmitter interacts with the receiver to generate imaging data that describes a particular section of the pipe,
a second receiver motor that is attached to the second end of the arc-shaped receiver arm and that is configured to position the receiver relative to the arc-shaped receiver arm, and
a receiver counterweight that is attached to the first end of the arc-shaped receiver arm.

2. The pipeline crawler of claim 1, wherein the arc-shaped transmitter arm has a first radius and the arc-shaped receiver arm has a second radius that is equal to the first radius of the arc-shaped transmitter arm.

3. The pipeline crawler of claim 2, wherein the first radius and the second radius are each greater than a radius of the pipe.

4. The pipeline crawler of claim 1, wherein the first transmitter motor is configured to position the arc-shaped transmitter arm relative to the center of the pipe by rotating the arc-shaped transmitter arm around the center of the pipe.

5. The pipeline crawler of claim 1, wherein a weight of the transmitter counterweight and a weight of the receiver counterweight are selected so as to place an overall center of mass of the pipeline crawler above the center of the pipe.

6. The pipeline crawler of claim 1, further comprising one or more mounts for supporting the pipeline crawler atop a pipeline.

7. The pipeline crawler of claim 6, wherein each mount of the one or more mounts comprises a respective wheel that is connected to the chassis.

8. The pipeline crawler of claim 7, further comprising a drive motor that:
(i) is affixed to the chassis; and
(ii) is configured to rotate a wheel connected to the chassis so as to move the pipeline crawler along the pipeline.

9. A method for inspecting a pipe using a pipeline crawler, the method comprising:
positioning, using a first transmitter motor, an arc-shaped transmitter arm of a transmitter assembly relative to a center of the pipe, wherein the transmitter assembly is connected to a chassis of the pipeline crawler and includes the first transmitter motor;
positioning, using a second transmitter motor, a transmitter of the transmitter assembly relative to the arc-shaped transmitter arm, wherein the transmitter is disposed on a first end of the arc-shaped transmitter arm;
positioning, using a first receiver motor, an arc-shaped receiver arm of a receiver assembly relative to the center of the pipe, wherein the receiver assembly is connected to the chassis of the pipeline crawler and includes the first receiver motor;
positioning, using a second receiver motor, a receiver of the receiver assembly relative to the arc-shaped receiver arm, wherein the receiver is disposed on a second end of the arc-shaped receiver arm; and
generating an image of the pipe using the positioned transmitter disposed on the first end of the positioned arc-shaped transmitter arm and the positioned receiver disposed on the second end of the positioned arc-shaped receiver arm.

10. The method of claim 9, further comprising:
positioning, using the first transmitter motor, a transmitter counterweight of the transmitter assembly relative to the center of the pipe, wherein the transmitter counterweight is attached to a second end of the arc-shaped transmitter arm.

11. The method of claim 10, further comprising:
positioning, using the first receiver motor, a receiver counterweight of the receiver assembly relative to the center of the pipe, wherein the receiver counterweight is attached to a first end of the arc-shaped receiver arm.

12. The method of claim 11, further comprising:
selecting a weight of the transmitter counterweight; and
selecting a weight of the receiver counterweight;
wherein the weight of the transmitter counterweight and the weight of the receiver counterweight are each selected so as to place an overall center of mass of the pipeline crawler above the center of the pipe.

13. The method of claim 9, further comprising:
supporting the pipeline crawler atop a pipeline using one or more mounts, wherein each mount of the one or more mounts comprises a respective wheel that is connected to the chassis of the pipeline crawler.

14. The method of claim 13, further comprising:
using a drive motor affixed to the chassis to move the pipeline crawler along the pipeline, wherein the drive motor is configured to rotate a wheel connected to the chassis to cause the pipeline crawler to move along the pipeline.

15. The method of claim 9, wherein generating the image of the pipe comprises:
generating multiple discrete images that each capture information about a respective interior section of the pipe; and
generating the image of the pipe in response to combining each of the multiple discrete images.

16. The method of claim 9, wherein positioning the arc-shaped transmitter arm relative to the center of the pipe comprises:
rotating the arc-shaped transmitter arm around the center of the pipe.

17. The method of claim 9, wherein:
the arc-shaped transmitter arm has a first radius and the arc-shaped receiver arm has a second radius that is equal to the first radius of the arc-shaped transmitter arm; and
the first radius and the second radius are each greater than a radius of the pipe.

18. A method for manufacturing a pipeline crawler comprising:
providing a chassis;
connecting a transmitter assembly to the chassis, the transmitter assembly including:
an arc-shaped transmitter arm having a first end and a second end,
a first transmitter motor that is configured to position the arc-shaped transmitter arm relative to a center of the pipe,
a transmitter disposed on the first end of the arc-shaped transmitter arm,
a second transmitter motor that is attached to the first end of the arc-shaped transmitter arm and that is configured to position the transmitter relative to the arc-shaped transmitter arm, and
a transmitter counterweight that is attached to the second end of the arc-shaped transmitter arm; and
connecting a receiver assembly to the chassis, the receiver assembly including:
an arc-shaped receiver arm having a first end and a second end,
a first receiver motor that is configured to position the arc-shaped receiver arm relative to the center of the pipe,
a receiver disposed on the second end of the arc-shaped receiver arm, wherein the transmitter interacts with the receiver to generate imaging data that describes a particular section of the pipe,
a second receiver motor that is attached to the second end of the arc-shaped receiver arm and that is configured to position the receiver relative to the arc-shaped receiver arm, and
a receiver counterweight that is attached to the first end of the arc-shaped receiver arm.

19. The method for manufacturing the pipeline crawler of claim 18, further comprising:
connecting one or more mounts to the chassis to support the pipeline crawler atop a pipeline, wherein each mount of the one or more mounts comprises a respective wheel that is connected to the chassis.

20. The method for manufacturing the pipeline crawler of claim 19, further comprising:
affixing a drive motor to the chassis and to the one or more mounts connected to the chassis, wherein the drive motor is configured to rotate the respective wheel connected to the chassis so as to move the pipeline crawler along the pipeline.
